(19) United States
(12) Patent Application Publication
(10) Pub. No.: US 2016/0106030 A1
(43) Pub. Date: Apr. 21, 2016

(54) Assist device for lawn mower and method of use

(71) Applicants: Ken Lundgren, Blaine, MN (US); Thomas Inwood, Arden Hills, MN (US)

(72) Inventors: Ken Lundgren, Blaine, MN (US); Thomas Inwood, Arden Hills, MN (US)

(21) Appl. No.: 14/399,131

(22) PCT Filed: Sep. 12, 2014
(86) PCT No.: PCT/US2014/055417

§ 371 Date: Nov. 5, 2014

Related U.S. Application Data
(60) Provisional application No. 61/876,937, filed on Sep. 12, 2013.

(51) Int. Cl. A01D 34/00

(52) U.S. Cl. CPC A01D 34/001; A01D 2101/00

(57) ABSTRACT

An assist device 12 for and method for using the assist device for exiting a zero turn lawn mower 16 or adjusting a cutting deck height of a zero turn lawn mower 16 having an operator deck 36 and an operator seat proximate the operator deck 36 wherein the assist device 12 is attached and extends upwardly from the deck 36 and is positioned forward of the operator seat and comprises a hand hold section 26 for gripping to aid an operator in reaching a standing position on the operator deck 36. The device 12 is secured to the top surface of the riding lawn mower wherein the base 16 of the assist device 12 is adapted for connection with an angled surface such that the device 12 remains in an upright position allowing the operator to grip the device 12 along the hand hold section 26 to assist the operator in positioning on the mower 16, entering and/or exiting the mower 16 and adjusting the height of the cutting deck 18.

### CROSS REFERENCE TO RELATED APPLICATION

This application is a Section 371 National Stage Application of International Application No. PCT/US2014/055417, filed Sep. 12, 2014, which claims priority to and benefits of U.S. provisional patent application Ser. No. 61/876,937, filed Sep. 12, 2013, the contents of which are incorporated herein by reference in their entirety.

### FIELD OF THE INVENTION

This invention relates to an assist device for use with a riding lawn mower. The device assists a user with getting on and off of the riding lawn mower and can be used for user stability while sitting on or operating the mower if needed.

### BACKGROUND OF THE INVENTION

A zero turn lawn mower is a standard riding lawn mower with a turning radius that is effectively zero. These types of lawn mowers are larger than a standard mower and have a seat generally positioned above a cutting deck such that an operator must step on top of a floor positioned above the cutting deck to sit in the operator's chair to drive and operate the mower.

The generally flat surface of the floor above the cutting deck allows the operator to enter and exit the lawn mower and provides access to the seat. When sitting in the seat, which is generally low to the ground, it may difficult to maneuver from seated to standing position or standing to seated position.

In the prior art, the only devices than an operator may have used for increased stability in exiting and entering the floor include the actual steering and/or drive controlling components, which are generally of an insufficient height to adequately aid the operator and may be inadvertently activated causing the mower to lurch or unexpectedly move if used as an assist device by the operator for exiting or entering the mower.

### SUMMARY OF THE INVENTION

The present invention relates to an assist device for a zero turn lawn mower. The lawn mower assist device is made for attachment to the lawn mower and comprises an upwardly extending handle secured to a top, generally inclined (angled) facing surface of a riding lawn mower. The base of the handle is typically adapted for connection with the angled surface of the lawn mower such that the handle remains in a generally upright position allowing an operator to grip the handle to assist the operator in positioning the operator on the Mower or in exiting the mower.

The present invention also relates to a method of exiting a zero turn lawn mower using an assist device. The method of exiting a zero turn lawn mower having an operator deck and an operator seat proximate the operator deck comprises providing an assist device that extends upwardly from the deck and is positioned forward of the operator seat. The device has a hand hold section for gripping and the method further comprises gripping the hand hold section from a sitting position to aid in reaching a standing position on the operator deck and further comprises exiting the operator deck with the aid of the assist device.

The present invention also relates to a method of adjusting the height of a cutting deck of a zero turn lawn mower using an assist device. The method of adjusting the cutting deck of a zero turn lawn mower having an operator deck and an operator seat proximate the operator deck comprises providing an assist device that extends upwardly from the deck and is positioned proximate a foot pedal for adjusting the cutting deck and forward of the operator seat. The device has a hand hold section for gripping and the method further comprises gripping the hand hold section from a sitting or standing position while also depressing a deck adjustment foot pedal.

### BRIEF DESCRIPTION OF THE DRAWINGS

FIG. 1 is a side view of an assist device.

FIG. 2 is a front view of the assist device.

FIG. 3 is an exploded perspective view of the assist device.

FIG. 4 is a perspective view of an assist device installed for use.

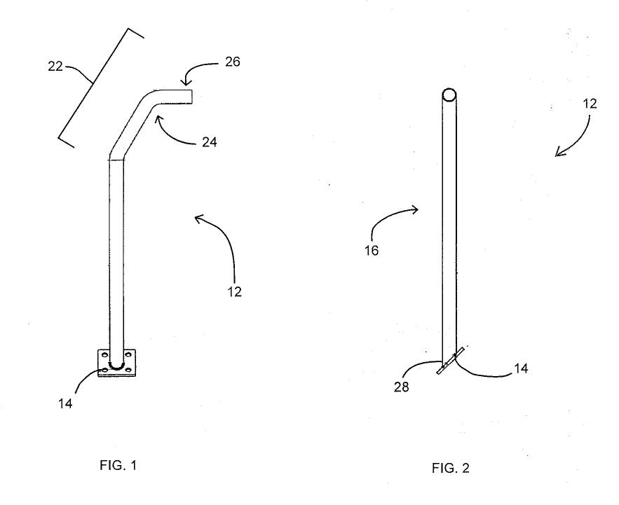

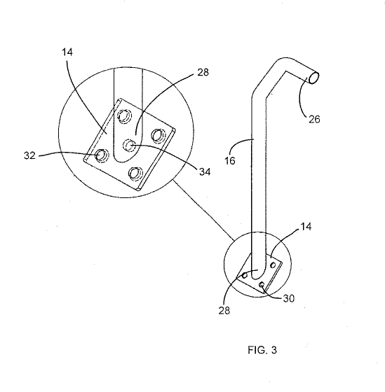

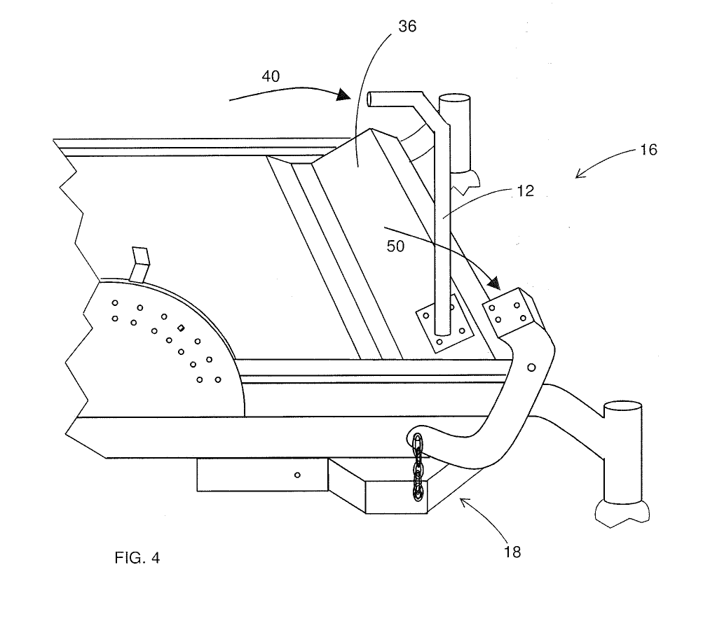

### DETAILED DESCRIPTION

The assist device 10 generally comprises a handle 12 and a connection plate 14, for connection to a top portion 36 of a riding lawnmower or zero turn lawnmower 16, proximate a seat for a user or an operator. As used throughout this description, the terms “user” and “operator” are interchangeable.

The handle 12 comprises a tube or bar, comprised of, for example, 14-gauge steel, aluminum, or any suitable material that maintains stability and structural integrity. The handle 12 is approximately 1.25 inches in diameter to provide for comfortable use with adult hands. The assist device of this invention is generally to) be used as an after-market device such that the device is sold as an attachment to be secured to any one of various zero-turn lawnmower makes or models. Moreover, the assist device can provide additional benefits to operators with health or physical issues that may otherwise prevent the operator from operating a riding lawn mower. The assist device assists operators who may become fatigued easily and also helps to reduce user bending when climbing onto or off of a mower equipped with the assist device. The device also provides stability for an operator when sitting or standing up from a seated position on the mower, or when adjusting cutting deck height while eliminating the need to use other components of the mower for stability that may not be able to withstand the operator's force or weight.

The handle 12 is adapted such that the handle 12 comprises a portion 16, of substantially straight and level length. The base 20 extends upwardly from connection with the mower floor approximately 19-20 inches for use with an average sized adult. Varying heights may be used depending on the size and height of the user. The distal section 22 of the handle 12 is adapted with a slight bend 24 or reasonable curvature along the length such that a distal end section 26 of the handle 12 is substantially perpendicular to the base 20 of the handle 12. In one example, the distal section 22 is approximately eight (8) inches long wherein the distal end section 26 is approximately 2.8-3 inches long. The distal end section 26 is the portion which a user will grip or grab with their hand and in one embodiment is positioned generally horizontally. This end section 26 may also be foam covered, or a cushion-type material may be provided to surround the end section 26 for gripping to provide comfort when in use and to reduce slippage of the operator's hand.

The proximal end of the section of the handle 12 proximate the base 16 is adapted with a modified end portion 28. The end portion 28 is essentially cut at an approximately 45-degree angle. This modified end is adapted for connection to the connection plate 14. The modified end portion 28 may be cut to any angle for attachment to various angled or slanted top surface sections of the mower as the assist device is mounted forward of the seat and the operator of the mower and may be offset to one side for ease of use and to avoid being a hindrance in operating the mower.

The connection plate 14 comprises a steel or aluminum plate. In the embodiment illustrated in the figures, the connection plate 14 measures approximately 3.25 inches on each side. The plate is adapted with five apertures. Four of the apertures 30, are positioned equally around the plate and adapted for insertion: of a suitable fastener 32. The fifth aperture 34 is centered in the connection plate 14 at the point of connection to modified end portion 28 of the handle 12. The fasteners 32 may be a nut and bolt or any other suitable type of stable but removable fastener. The connection plate 14 is secured integrally to the modified end portion 28 of the handle 12. The connection plate 14 may be secured by welding the plate 14 to the end portion 28.

In the embodiment illustrated in the figures, the connection plate 14 is secured to the handle at the modified end portion 28 and at an angle approximately 45 degrees. Thus, the plate is retained at an angle while the handle remains substantially vertical when extending from its connection with the zero-turn lawn mower.

The plate 14 is secured to a front, top surface 36 of a floor of the lawn mower 16. The position for securing the handle is selected such that the handle is within reach of a user as the user sits down or stands up with respect to the seat. Preferably, the handle is also positioned on the top of the floor of the lawn mower off to one side. The handle is thus generally at the height of an adult's outstretched arm while the adult is seated. As the area for securing the handle is generally within an arm's reach of the adult while seated on the mower, the handle is generally secured proximate the front wheels of the mower.

This area is generally in a forward position on the top of the floor of the lawn mower 16. This area may include an angled section extending laterally across the front of the floor of the mower or may be a section of iron welded to the floor at an angle and extending laterally for extra support and stability for the lawn mower. This area also provides an angled surface for attachment of the assist device 12. As such, the connection plate is secured via fasteners to the angled surface 36. The connection plate 14 is secured substantially flush with the angled surface 36 of mower 16, the plate and the surface both being at an angle. This allows the handle to extend upwardly from the mower in a substantially vertical configuration. The distal end section 26 of the handle, bent as described previously, turns inward toward the center of the lawnmower and substantially parallel to a front edge of the seat, such that it is easy for a seated user to comfortably grip the end portion 28 of the handle. The handle thus allows the user to be assisted when getting out of the seated position as well as assisting a user in getting onto the floor of the mower itself. The handle also provides stability to a user when the user is adjusting the cutting deck 18 of the mower 16, which is under the floor and seat.

The device 12 can be secured at any position along the lateral surface 36. For example, the off-set position of the device may be adjusted based on the side from which an operator steps onto the floor of the mower, or depending on the hand dominance of the user. The device 12 can also be secured to the surface 26 proximate a foot pedal for adjusting the height of the lawnmower cutting deck 18. The height of the deck is generally adjusted manually by the operator. The operator would depress a foot pedal, the pressure and distance of the depress determining the extent of the raising of the cutting deck or whether the deck will be lowered. The cutting deck includes a housing and blade that are made of metal and therefore the cutting deck is heavy and requires some force to raise and lower the cutting deck. The handle 12 positioned near this foot pedal allows the operator to grip the handle for stability and leverage while depressing the foot pedal and adjusting the height of the cutting deck 18.

As illustrated in FIG. 4, arrows 40 and 50 are used to demonstrate the method of using the handle. Arrow 40 generally represents the direction of the operator grip when using the handle in moving from a seated position to a standing position, standing position to seated position, or when adjusting the height of the cutting deck 18. Arrow 50 generally represents the direction in which the operator may apply force to the foot pedal for adjusting the cutting deck height when also gripping the handle.

Positioning of the device on the mower as described previously throughout this disclosure further allows the user to take advantage of additional leverage, especially when exiting the mower or rising from a seated position. The device can also be used for stability when sitting in the seat.

Although the present invention has been described with reference to preferred embodiments, workers skilled in the art will recognize that changes may be made in form and detail without departing from the spirit and scope of the invention.

What is claimed:

1. A method of exiting a zero turn lawn mower having an operator deck and an operator seat proximate the operator deck, the method comprising:
providing an assist device that extends upwardly from the deck and positioned forward of the operator seat, the device having a hand hold section for gripping;
gripping the hand hold section from a sitting position to aid in reaching a standing position on the operator deck;
exiting the operator deck with the aid of the assist device.

2. The method of claim 1 further comprising the step of securing the assist device on an angled surface of the operator deck such that the assist device is substantially vertical.

3. The method of claim 1 wherein gripping the hand hold section further comprises gripping a section extending transversely to the upwardly extending section of the device.

4. The method of claim 1 and further comprising the step of gripping the assist device when manually adjusting a cutting deck height.

5. A method of adjusting the height of a cutting deck of a zero turn lawn mower having an operator deck and an operator seat proximate the operator deck, the method comprising:
providing an assist device that extends upwardly from the deck and is positioned proximate a foot pedal for adjusting the height of the cutting deck and forward of the operator seat, the device having a hand hold section for gripping;
gripping the hand hold section from a sitting or standing position; and
depressing the foot pedal to adjust the height of the deck.

6. The method of claim 5 further comprising the step of securing the assist device on an angled surface of the operator deck such that the assist device is substantially vertical.

7. The method of claim 5 wherein gripping the hand hold section further comprises gripping a section extending transversely to the upwardly extending section of the device.

8. The method of claim 5 and further comprising the step of gripping the hand hold section when rising from a seated position to exit the mower.

9. A lawn mower assist device for attachment to the lawnmower, the device comprising:
an upwardly extending handle secured to a floor of a riding lawn mower wherein a base of the handle is adapted for connection with an angled surface of the floor such that the assist device remains secured in an upright position for a user to grip the handle to assist the user in positioning the user on the mower.

10. The assist device of claim 9 wherein the upwardly extending handle further comprises a grip section extending approximately transversely to the upwardly extending base of the handle.

11. The assist device of claim 10 wherein the grip section is further adapted with a cushion extending around the grip section.

12. The assist device of claim 10 wherein the based is secured to the floor of the lawn mower by connection of the base of the device with a substantially flat plate, the plate being secured to the angled surface of the floor of the lawn mower.

13. The assist device of claim 10 wherein the base is secured to the angled section of the top surface of the lawn mower by connection of the base of the device with a substantially flat plate, the plate in connection with the angled top surface of the lawn mower.
